(19) United States
(12) Patent Application Publication
(10) Pub. No.: US 2022/0228723 A1
(43) Pub. Date: Jul. 21, 2022

(54) Asymmetrical Optics for Linear Lighting

(71) Applicant: Elemental LED, Inc., Reno, NV (US)

(72) Inventor: Raymond G. Bryan, Reno, NV (US)

(73) Assignee: Elemental LED, Inc.

(21) Appl. No.: 17/230,081

(22) Filed: Apr. 14, 2021

Related U.S. Application Data
(60) Provisional application No. 63/139,534, filed on Jan. 20, 2021.

(51) Int. Cl. F21V 5/08; F21V 5/04; F21S 4/28; G02B 27/00

(52) U.S. Cl. CPC F21V 5/08; G02B 27/0012; F21S 4/28; F21V 5/045

(57) ABSTRACT

A cover lens for a linear luminaire is disclosed. The cover lens has a body with a refractive portion and cover-engaging structure. The body has an inner surface with a plurality of facets, and an outer surface that is either continuously curved or splined. Each of the plurality of facets has a facet angle and a facet length. The plurality of facets are physically asymmetrical so as to cause or allow an asymmetrical refraction of light that is emitted toward their inner surfaces. The body of the cover lens has a constant cross section over its length. A linear luminaire using such a cover lens is also disclosed.

### CROSS-REFERENCE TO RELATED APPLICATIONS

This application claims priority to U.S. Provisional Patent Application No. 63/139,534, filed Jan. 20, 2021, the contents of which are incorporated by reference herein in their entirety.

### TECHNICAL FIELD

The invention relates to optics for linear lighting, and more specifically, to asymmetrical optics.

### BACKGROUND

Linear lighting is a class of solid-state lighting in which an elongate, narrow printed circuit board (PCB) is populated with a number of light-emitting diode (LED) light engines, spaced along the PCB at a regular pitch or spacing. In finished linear lighting luminaires, the PCB with the LED light engines is often installed in a channel, such as a metal or plastic extrusion, and covered with a cover. The cover serves a variety of purposes, for example, protecting the interior of the channel and preventing ingress of foreign material.

Some channel covers may also serve as lenses or other types of optical elements that modify the light emissions from the LED light engines, e.g., to constrain the emitted light beam to some smaller beam width than would otherwise be the case. As one example, U.S. Pat. No. 10,788,170, which is incorporated by reference in its entirety, discloses two-element optical systems suitable for installation in channels. The two elements may be, e.g., an inner lens and an outer lens, or an inner diffuser and an outer lens. While the lens systems taught by this patent are effective at constraining the beam width, and also address color issues specific to LED light engines, these systems emit light symmetrically in the same fundamental direction as it was originally emitted by the LED light engines.

There are many circumstances in which it is desirable for a linear luminaire to emit light in a specific direction different than the direction in which it would typically emit light. The usual solution in these circumstances is to use a custom channel profile that tilts or angles the PCB and its LED light engines to the desired emission angle. Alternatively, angled mounting brackets may be used with a conventional channel. However, these types of solutions are not appropriate for all installations, because they may consume more space than is available or have special mounting requirements that the installation cannot support.

### BRIEF SUMMARY

One aspect of the invention relates to a cover lens for a linear luminaire. The cover lens has a body with a refractive portion and cover-engaging structure. The body has an inner surface with a plurality of facets, and an outer surface that is either continuously curved or splined. Each of the plurality of faces has a facet angle and a facet length. The plurality of facets are physically asymmetrical so as to cause or allow an asymmetrical refraction of light that is emitted toward the inner surface. The body of the cover lens has a constant cross section over its length.

Another aspect of the invention relates to luminaires that include the kind of cover lens described above.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the description, and in which:

FIG. 1 is a perspective view of a channel and cover lens according to one embodiment of the invention;

FIG. 2 is a cross-sectional view of the channel and cover lens of FIG. 1;

FIG. 3 is a cross-sectional view and ray-trace diagram similar to the view of FIG. 2;

FIG. 4 is an optical diagram illustrating the path of a single ray of light through two optical interfaces, used to illustrate a portion of the method of designing an asymmetrical lens like that of FIGS. 1-3.

FIG. 5 is an optical diagram illustrating the path of three principal rays through an asymmetrical lens;

FIG. 6 is a luminous intensity plot, shown in polar coordinates, for the asymmetrical lens of Example 1;

FIG. 7 is a luminous intensity plot, shown in polar coordinates, for the asymmetrical lens of Example 2; and

FIG. 8 is a luminous intensity plot, shown in polar coordinates, for the asymmetrical lens of Example 3.

### DETAILED DESCRIPTION

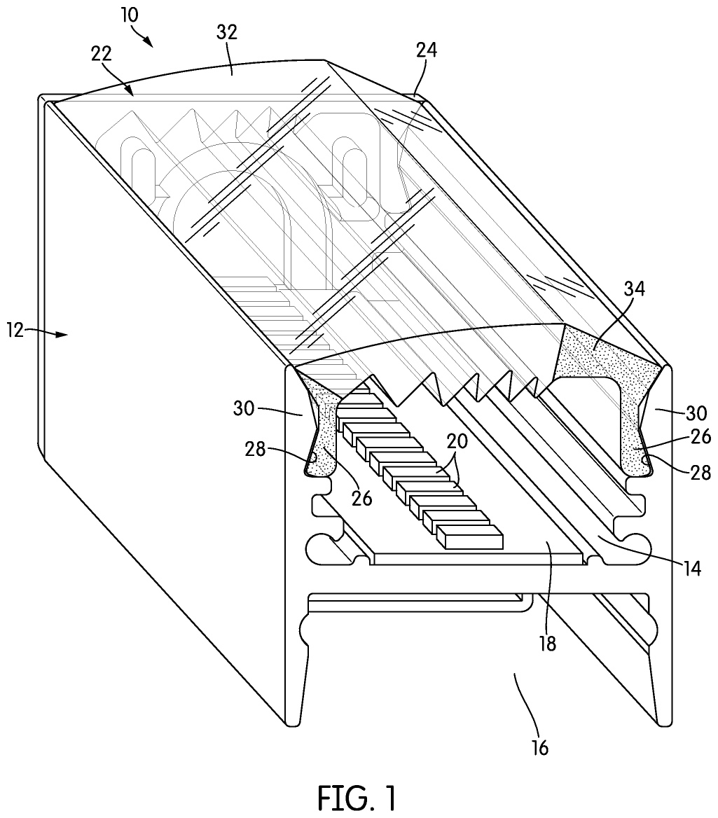

FIG. 1 is a perspective view of a linear luminaire, generally indicated at 10. The linear luminaire 10 includes a channel 12. The channel 12 in the illustrated embodiment includes an upper compartment 14 and a lower compartment 16. A strip of linear lighting including a narrow, elongate printed circuit board (PCB) 18 with a number of LED light engines 20 mounted on it and spaced at a regular interval or pitch is mounted at the bottom of the upper compartment 14. An LED light engine, as the term is used here, refers to one or more LEDs in a package. The package allows the light engine to be mounted on a PCB by a common technique, such as surface mounting. A cover lens 22 is mounted overtop the upper compartment 14. Typically, the ends of the channel 12 would be covered with endcaps 24, one of which is shown in the view of FIG. 1, and the other of which has been removed in order to illustrate the interior arrangement of the luminaire 10.

The channel 12 and the cover lens 22 are each assumed to have a constant cross-sectional shape over their respective lengths. Both elements 12, 22 are typically manufactured by extrusion, although they may also be injection molded, machined, or manufactured by other methods. There is no theoretical limit to the length of a channel 12 or its cover lens 22, although as a practical matter, these components may be limited to 2.5-3 meters in length in order to facilitate packaging and transportation.

The illustrated channel 12 is the channel described in U.S. patent application Ser. No. 17/130,935, filed Dec. 22, 2020, which is incorporated by reference in its entirety. The engagement between the channel 12 and the cover lens 22 is as described in that application. However, the cover lens 22, which will be described below in more detail, can be adapted for use with any type of channel. Typically, the channel has some sort of cooperating engaging structure in its sidewalls that allows it to engage with the cover lens 22. In this case, as described in the '935 application, the cover lens 22 has a pair of depending legs 26 that engage with complementary structure 28 on the upper, inner sidewalls 30 of the channel 12. In other embodiments, any such cooperating engaging structures that keep the cover lens on the channel may be used. This includes situations in which a cover lens without special mechanical engaging structure may be adhered or sealed to the channel 10 with an adhesive or encapsulant, rather than mechanically seated on it, in which case, the adherent or the surface(s) to which it is applied should be considered to be cooperating engaging structure or channel-engaging structure.

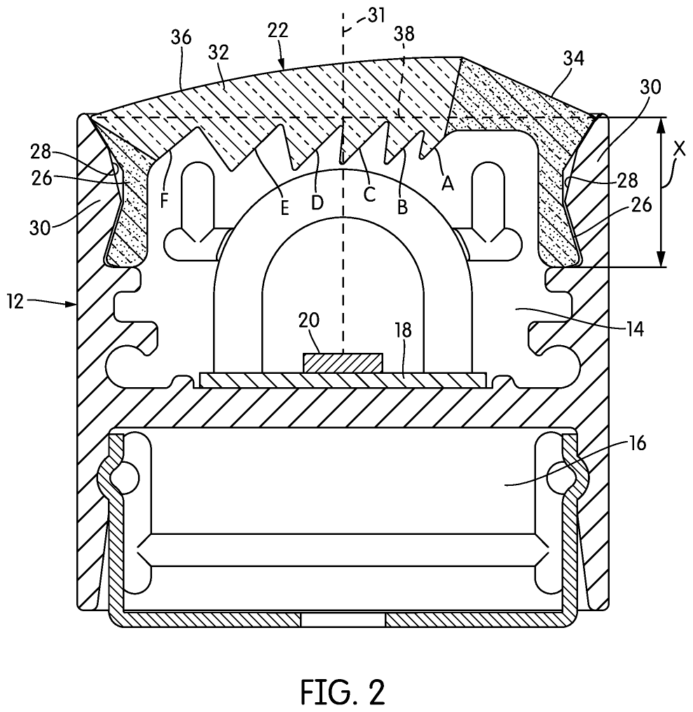

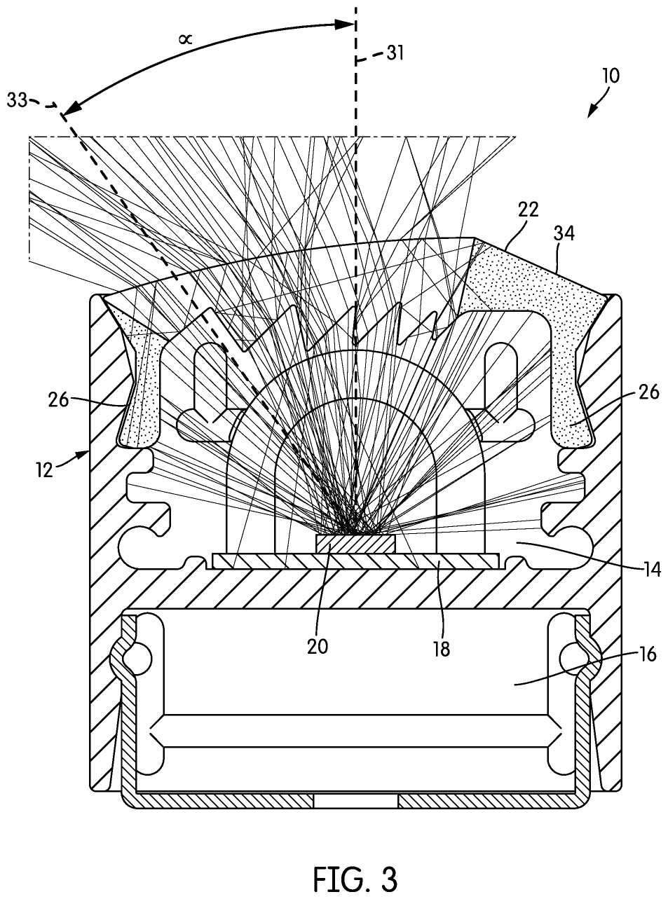

FIG. 2 is a cross-sectional view of the luminaire 10, illustrating, among other things, the shape of the cover lens 22. FIG. 3 is a ray-trace diagram, using a view similar to that of FIG. 2 to illustrate the paths of light rays emitted by the LED light engines 20 as they are refracted by the cover lens 22 out into the environment. In the following description, unless otherwise noted, it is assumed that the LED light engines 20 emit light symmetrically, centered about an axis indicated at 31 in FIGS. 2 and 3. It is also assumed that, as shown, the PCB 18 is centered on the bottom of the upper compartment 18 of the channel 12, and the LED light engines 20 are in a line aligned with the center of the PCB 18. The ray-trace diagram of FIG. 3 also assumes that the rays of light are emitted into air, a point that will be addressed in more detail below.

The cover lens 22 is designed to refract light asymmetrically, and to produce a beam width that is narrower than an unmodified beam width of the LED light engines. Here, the terms “asymmetric” and “asymmetrical,” when applied to light emission, refer to light emission that is more to one side than the other of an axis aligned with the usual centers of emission of the LED light engines 20. In this case, with no lens installed, light would typically be emitted along the axis 31 and symmetrically to both sides of it. With the cover lens 22 installed, instead of the peak luminous flux being emitted along a plane or axis 31 aligned with the centers of the LED light engines 20, the peak luminous flux is centered around a plane or axis 33 that lies at an angle α away from the axis 31, as shown in FIG. 3.

As a point of reference, a typical LED light engine 20 used in a luminaire like the luminaire 10 may have a beam width of approximately 120°. The cover lens 22 may produce a beam width of any lesser width, directed toward any angle α. In the illustrated embodiment, the angle α is 35°, and the beam width is 60°, half that of the typical unmodified beam width. In this description, beam widths are given as full width, half maximum (FWHM), unless otherwise noted. In this case, 60° FWHM means that the beam is 60° edge-to-edge, and at the edges, the luminous flux is half the luminous flux at the center of the beam. The asymmetrical refraction of the cover lens 22 and the more restricted beam width it offers can be appreciated from the ray-trace diagram of FIG. 3.

As can be seen in FIG. 2, the cover lens 22 includes a number of features that make possible the asymmetric light emission and narrowed beam width. First, while the cover lens 22 itself is made of a plastic material with an index of refraction higher than that of air, such as acrylic, polycarbonate, or PVC, only those portions from which light is to be emitted are transparent. In the illustrated embodiment, this means that only the center-left portion 32 of the cover lens 22 is transparent; the legs 26 and a far-right portion 34 of the cover lens 22 are colored with an opaque colorant. Here, the terms “left” and “right” are used with respect to the coordinate system of FIGS. 2 and 3. The opacity of some sections of the cover lens 22 prevents or retards the transmission of light through those sections.

The transparent portion of the cover lens 22 has an inner surface with a number of facets that face the LED light engines 20, and an outer surface 36 that is either continuously convexly curved or convexly splined. In FIGS. 2 and 3, there are six facets, labeled A through F, on the inner surface.

Given this arrangement, refraction occurs at the facets A, B, C, D, E, F and at the outer surface 36. That is, the angles and lengths of the facets A, B, C, D, E, F, as well as the characteristics of the outer surface 36, define where light goes and what the beam width is. There may be any number of facets in a cover lens 22, more or fewer than the six facets A, B, C, D, E, F of the illustrated embodiment. The facets A, B, C, D, E, F may be of equal angle and facet length, or they may differ in one or both of angle or facet length. As was noted briefly above, the outer surface 36 may form a continuous curve, or it may be a spline (i.e., a discontinuous set of curves) that provides a different curvature, and thus, a different refractive behavior, corresponding to each of the facets A, B, C, D, E, F.

The design of a lens like the cover lens 22 may initially begin with certain assumptions. For example, for design purposes, it may be assumed initially that the facets A, B, C, D, E, F and the outer surface 36 will each perform half of the refraction necessary to refract the light toward the angle α. A design may also initially begin with the assumption that the facets A, B, C, D, E, F will be of equal size, and that the outer surface 36 will be in the form of a spline with a segment corresponding to each of the facets. The angles of the facets A, B, C, D, E, F can be derived, under these assumptions, from an iterative process using Snell's Law, given the desired angle α and the refractive index of the material of which the cover lens 22 is to be made. The lengths and angles of the facets A, B, C, D, E, F can then be adjusted, if needed, to create a desired beam angle. If the splines that comprise the outer surface 36 approximate a single continuous curve closely enough, that single curve may replace the splines.

With respect to facet angles and lengths, the present inventor has found that if one calculates an ideal solution (i.e., number of facets, facet angles, facet lengths) for refracting light toward the angle α, the result will likely be cover that produces a light beam that is indeed centered at the angle α, but with a narrow beam width on the order of 10-15°. If a wider beam width is desired, adjusting the lengths and angles of the facets somewhat can help to create that wider beam width.

A cover lens according to embodiments of the invention may contain any number of facets, although considerations like manufacturability and the fineness of the features may influence the number of facets. In designing a cover lens and determining the number of facets, it may be helpful to begin by examining the emitted light at some regular angular interval from the axis of emission 31 of the LED light engines 20. (The axis of emission 31 may also be referred to as the normal to the center of the emitting surface of the LED light engine 20.). For example, tracing the path of a light ray at 10° intervals from the axis 31 may be a suitable way to determine appropriate properties for the facets without incurring an overwhelming computational burden.

In the illustrated embodiment, facet A has an angle of 45° with respect to the axis 31 and a facet length of 2.00 mm; facet B has an angle of 45° and a facet length of 2.50 mm; facet C has an angle of 45° and a facet length of 3.00 mm; facet D has an angle of 45° and a facet length of 3.00 mm; facet E has an angle of 45° and a facet length of 3.00 mm; and facet F has an angle of 50° and a facet length of 2.77 mm. With these dimensions, the term “facet length” refers to the length of the facet as measured along its length (i.e., its angled length); it does not refer to the vertical height of the facet as measured from its base or root. In most cases, radii of curvature may be added at the roots and tips of the facets in order to avoid sharp angles, aid in manufacturability, and prevent stress concentrators that may cause mechanical failure in use. The lengths and distances specified here are given as distances before the addition of any radii.

Because many of the facets A, B, C, D, E have the same facet angles but different lengths, they give the visual impression of a ragged or uneven set of teeth. The unlabeled return surfaces opposite the facets A, B, C, D, E are not critical to the overall refractive properties of the cover lens 22 and may be specified as needed. That said, it may be advantageous to choose angles for the return surfaces such that the return surfaces are substantially aligned with the light rays coming from the LED light engines. Choosing the angles of the return surfaces in this way ensures that the return surfaces have minimal interaction with the incoming light rays and, as much as possible, do not block the light rays from reaching the refractive facets A, B, C, D, E, F. In this case, the return surface for facet A has an angle of 11.96°, the return surface for facet B has an angle of 6.76°, the return surface for facet C has an angle of 6.29°, the return surface for facet D has an angle of 12.72°, and the return surface for facet E has an angle of 35.71°.

As those of skill in the art may note, the cover lens 22 is not a Fresnel lens, at least because the facets A, B, C, D, E, F are neither identical nor concentric about a center. In fact, in addition to providing asymmetrical light emission, the facets A, B, C, D, E, F are physically asymmetrical, in that there is no axis of symmetry along the inner face of the cover lens 22 about which the facets A, B, C, D, E, F are concentric or reflected. However, the facets A, B, C, D, E, F share some conceptual heritage with the facets of a Fresnel lens, in that, in both cases, it is the angle of the facet, and not its thickness, that determines its refractive effect. Along those lines, while the thickness of the facets A, B, C, D, E, F may vary from embodiment to embodiment, and they may be thicker in some cases to satisfy mechanical strength requirements or other concerns, they should generally be as thin as possible. In understanding the meaning of the terms “faceted lens” and “faceted surface,” it may be helpful to consider that while a Fresnel lens is a type of faceted lens, not all faceted lenses are Fresnel lenses.

In this embodiment, the outer surface 36 has the form of a convex lens of constant curvature. It has a radius of curvature of 50 mm centered at a point 5.00 mm to the right of the central axis 31, given the coordinate system of FIG. 2. The radius of curvature of the outer surface 36 intersects with an apex line 38 that is a distance X from the bottoms of the legs 26, as shown in FIG. 2. In embodiment of FIG. 2, the distance X is 6.27 mm, plus or minus 0.05 mm.

As can also be appreciated from FIG. 2, the roots of the facets A, B, C, D, E, F lie closer to the bottoms of the legs 26 than the apex line 38, at positions dependent on their facet lengths and angles. In this case, the base or root of facet A lies along a line 5.73 mm from the bottoms of the legs 26; the base or root of facet B lines along a line 5.90 mm from the bottoms of the legs 26; the base or root of facet C lies along a line 6.26 mm from the bottoms of the legs 26; the bases or roots of facets D and E lie along a line 6.08 mm from the bottoms of the legs 26; and the base or root of facet F lies along a line 5.91 mm from the bottoms of the legs 26. All of these dimensions may have a specified tolerance of, e.g., plus or minus 0.200 mm.

In the design and construction of a cover lens 22, the material into which light is to be emitted is taken into account during the design process, as its refractive index is used in Snell's Law calculations. That material should also be taken into account in determining the environments where the luminaire 10 can and should be installed. For example, the shapes and dimensions illustrated in FIGS. 1-3 assume that the luminaire 10 will be installed and emit into air. It is also assumed that the material of which the cover lens 22 is made will have a refractive index in the range of about 1.4-1.6, which covers most plastics. For example, an acrylic plastic such as Evonik Acrylite 8N (Evonik Industries, Essen, Germany), which is a particularly suitable material for the cover lens 22, has a refractive index of 1.492. Particularly for certain special applications, a cover lens according to an embodiment of the invention could be made of a material with a higher refractive index, such as sapphire. The facet lengths and angles would be different with different materials.

Luminaires that have water resistance and that can be operationally immersed in water and other fluids can be made, either by sealing or encapsulating portions of the channel 12. If the luminaire is to emit into water, for a refractive effect similar to the effect of the luminaire 10 described above, the facet lengths and angles would be recalculated and a custom cover lens would be constructed for the environment.

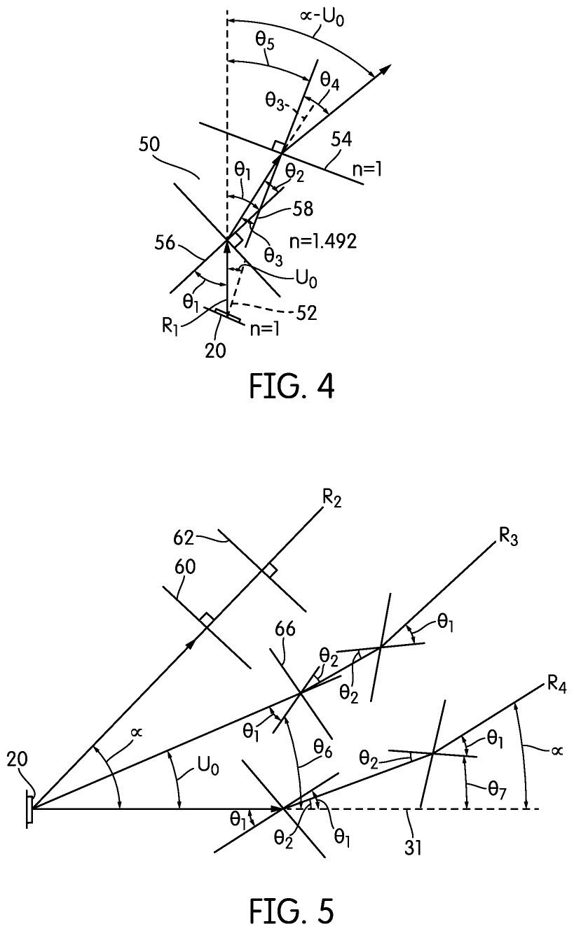

The process of determining the angles and extents of the facets is the same regardless of the desired angle α at which light is to be directed. FIG. 4 is an optical ray diagram illustrating the path of a single ray of light, indicated as R₁, as it is emitted by an LED light engine 20 and passes from air into an optical medium 50. The diagram of FIG. 4 follows from Snell's Law, the basic law of refractive optics, and assumes that the LED light engine 20 emits the light ray R₁ into air, refractive index (n) of 1. The optical medium 50 has an inner surface 52, which would be a facet in a faceted lens, and an outer surface 54, which would typically be a curve or a spline in a faceted lens. In the diagram of FIG. 4, U₀ is the angle between the normal 31 to the surface of the LED light engine 20 and the angle of emission of the ray R₁. The ray R₁ is emitted toward the inner surface 52 and makes an angle with the normal 56 to the inner surface 52 of θ₁. Relative to the normal 56 to the inner surface 52, the ray R₁ is bent at the interface between air and the inner surface 52 to an angle θ₂. The bent ray R₁ makes an angle of θ₃ with the normal 58 to the outer surface 54 as it strikes the outer surface 54, is bent at the interface between the outer surface 54 and the air and is emitted at an angle of θ₄ with respect to the normal 58 to the outer surface 54. The overall relationship between the angles can be expressed as follows:

∝−U₀=θ₁−θ₂+θ₄−θ₃ (1)

And further:

θ₅=α−θ₄ (2)

As described above, it may be assumed in at least some lenses that about half of the refraction is done at the inner surface 52 and about half the refraction is done at the outer surface 54. In the terms of FIG. 4, this means that θ₁=θ₄. By Snell's Law:

$$\begin{matrix}{θ}_{2} = {sin}^{- 1} ( \frac{sin {θ}_{1}}{n} ) \\ & ( 3 ) \\ {θ}_{3} = {sin}^{- 1} ( \frac{sin {θ}_{4}}{n} ) & ( 4 )\end{matrix}$$

Where n is the index of refraction of the lens material.

When Equations (1)-(4) are manipulated algebraically, they yield:

$${θ}_{1} = \frac{a - {U}_{0}}{2} + {sin}^{- 1} ( \frac{{sin θ}_{1}}{n} ) \qquad ( 5 )$$

As those of skill in the art might appreciate, Equation (5) is self-referential and thus not readily solved algebraically. It can be solved numerically by choosing values for θ₁ in the expression on the right side of the equation and solving iteratively until the equation is true. Once θ₁, the angle between the ray R₁ and the normal 56 to the inner surface 52 is found, the angle of the inner surface 52 relative to the normal 31 to the surface of the LED light engine 20, also called the facet angle, and referred to mathematically as θ₆ in this description, can be calculated as follows:

θ₆=U₀+θ₁ (6)

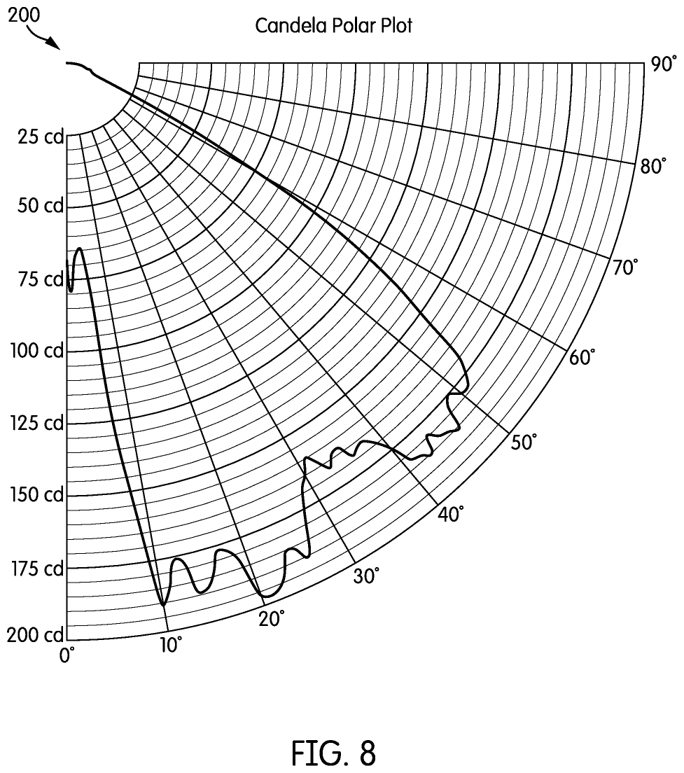

FIG. 8 is a diagram that extends this concept. In FIG. 8, three light rays R₂, R₃, R₄ are modeled using the same basic computational technique described above. Light ray R₂ is emitted from the LED light engine 20 at an angle equal to the desired angle α. In this case, the first surface 60 and the second surface 62 are both set normal to ray R₂, which means that ray R₂ exits the lens at the same angle at which it was emitted.

Light ray R₃ is emitted by the LED light engine 20 at an angle U₀ relative to the normal 31 to the surface of the LED light engine 20. For this ray, θ₁ is calculated from Equation (5) above. Once again, the value of θ₁ can be found by iteratively selecting values for θ₁ on the right side of the equation until a value emerges that makes the equation true. This relationship holds for any angle U₀.

In the case of light ray R₄, U₀ is zero, since ray R₄ is aligned with the normal to the surface of the LED light engine 20. Thus, for light ray R₄, Equation (5) simplifies to:

$${θ}_{1} = \frac{a}{2} + {sin}^{- 1} ( \frac{{sin θ}_{1}}{n} ) \qquad ( 7 )$$

This technique thus specifies the angle θ₁. As those of skill in the art will note, all of the rays R₂, R₃, R₄ in FIG. 8 are emitted on the same side of the LED light engine 20. The same technique may be used to calculate facet angles for rays on the other side of the normal 31 to the surface of the LED light engine 20, with U₀ as a negative angle.

By the diagram of FIG. 8, θ₁ is the angle that the ray R₂, R₃, R₄ makes with respect to the normal to the first or facet surface 60, 66, 68. It should be noted that the value of θ₁ is different for each of the three rays R₂, R₃, R₄. As was noted above, θ₆ is the angle that the facet surface 60, 66, 68 makes with respect to the normal 31 to the emitting surface of the LED light engine 20, and is what this description refers to as the facet angle. The facet angle, θ₆, is calculated using Equation (6), as described above.

### EXAMPLES

### Example 1: Narrow Beam Asymmetrical Lens

A five-facet asymmetrical lens in acrylic, n=1.492, was modeled assuming a desired angle α of 35° using five principal rays emitted at an angle U₀ relative to the normal of the LED light engine of 0°, 17.5°, 35°, −17.5° and −35° as shown below in Table 1:

TABLE 1
Calculated angles for specified principal ray angles in Example 1.

| Principal | Calculated θ₁ | Calculated θ₆ |
|---|---|---|
| Ray Angle | (Equation (5)) | (Facet Angle, Equation (6)) |
| 0° | 46.7° | 46.7° |
| 17.5° | 25.6° | 43.1° |
| 35° | 0.0° | 35.0° |
| −17.5° | 62.8° | 45.3° |
| −35° | 75.5° | 40.5° |

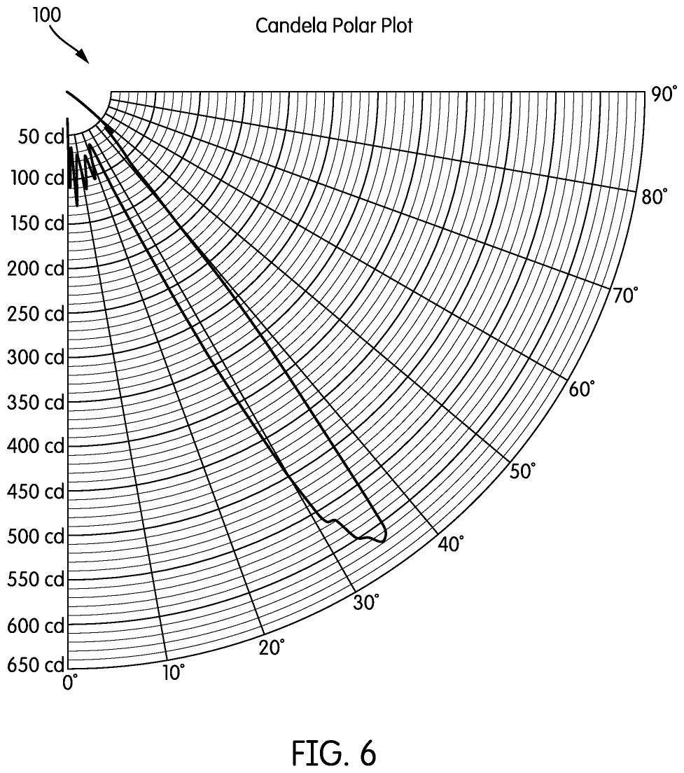

The facets were assumed to have an equal facet length of 3 mm. It was also assumed that half the refraction would be done by the inner facet and half the refraction would be done by the outer surface of the lens. The resulting lens was modeled using ray-trace modeling software and a polar light emission plot in candela was created. This polar luminous intensity plot, generally indicated at 100 in FIG. 6, and in units of candela (Cd) showed a tight beam with an approximately 10° beam width having a center of emission at 35°. This result verifies the basic calculation techniques described here and demonstrates that an asymmetrical lens can be designed with these techniques to produce an extremely narrow beam centered at a desired angle.

### Example 2: Initial 60° Beam-Width Lens

As an asymmetrical lens with a broader beam was desired, a five-facet asymmetrical lens similar to the lens of Example 1 was modeled with the same assumptions as to optical material and the same principal rays. The overall desired angle for the lens remained 35°. However, in contrast to Example 1, the individual facets were aimed differently. That is, instead of using the same desired angle α for each facet, each facet was given its own desired angle α₁. The desired angles α₁ were in the range of 5°-65° in this example, spaced from one another at 15° intervals. This, it was hoped, would center the resulting light beam around the overall desired angle α of 35°, while the different desired angles α₁ for each facet would spread the beam more. The facet lengths in this example were equal. The calculations are shown below in Table 2.

TABLE 2
Calculated angles for specified principal ray angles in Example 2.

| | | | Calculated θ₆ |
|---|---|---|---|
| Principal | Facet Desired | Calculated θ₁ | (Facet Angle, |
| Ray Angle | Aim Angle α₁ | (Equation (5)) | Equation (6)) |
| 0° | 35° | 46.7° | 46.7° |
| 17.5° | 50° | 44.0° | 61.5° |
| 35° | 65° | 41.2° | 76.2° |
| −17.5° | 20° | 49.2° | 31.7° |
| −35° | 5° | 51.8° | 16.8° |

Examples 1 and 2, as well as the description above, outline a general method for constructing asymmetric lenses of this type. One begins by choosing a defined angle α at which the light is to be aimed, as well as the optical material of which the lens is to be made. Based on the defined angle α, the size of the lens, and manufacturing considerations, one can choose the number of facets and select the angle of a principal ray (U₀) for each facet. In Examples 1 and 2, these principal rays were chosen as α, α/2, 0°, −α/2, and −α. If a narrow beam is required, each facet may be aimed at the defined angle α. If a wider beam is required, the facets can each be aimed separately at different angles in order to spread the beam. The effects of the facet angles can be tested and checked using ray-trace modeling.

Once the basic beam angle and beam width are set, small changes in facet angle and facet length can be used to improve the uniformity of the emitted beam, or to accentuate non-uniformity, if such is desired.

### Example 3: Use of Luminous Intensity Plot to Finalize Facet Characteristics

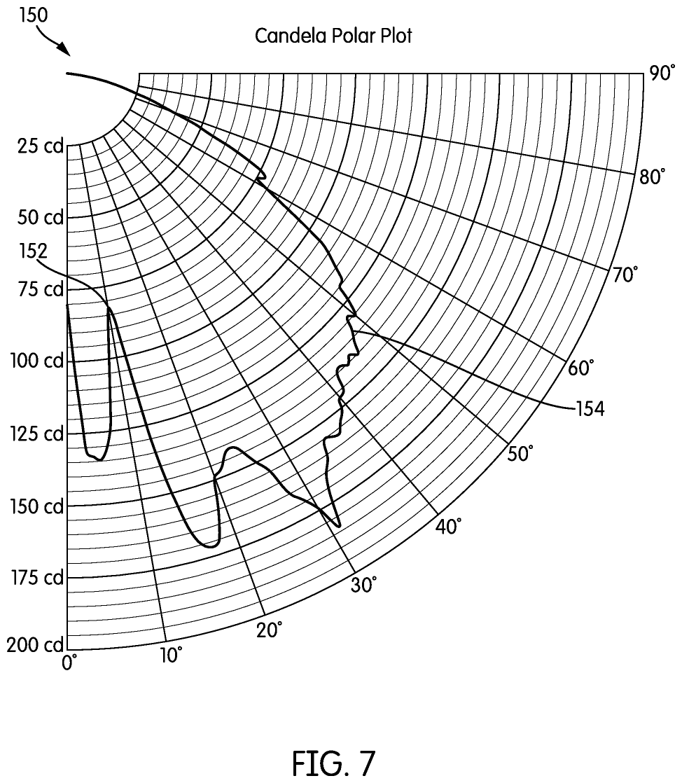

A six-facet asymmetrical lens in acrylic, n=1.492, was modeled assuming a desired angle α of 35°. The facet angles were set as described above with respect to facets A-F of FIGS. 1-3: 45°, 45°, 45°, 45°, 45°, and 50° with a facet length in each case of 3.00 mm. A luminous intensity plot was created for this modeled lens using ray trace software. That luminous intensity plot is generally indicated at 150 in FIG. 7.

The luminous intensity plot 150 of FIG. 7 shows a pronounced dip 152 in luminous intensity at 10° and a falloff 154 in luminous intensity beyond 40°. The dip 152 is interpreted as adjacent facets being too far apart, facets A and B are shortened in length to 2.00 mm and 2.50 mm, respectively, to address the dip 152; and facet F is shortened slightly to address a dip. Remaining facets C, D, and E have unchanged facet lengths at 3.00 mm.

The adjusted lens is modeled using ray-trace software and a new luminous intensity plot is created. This luminous intensity plot, generally indicated at 200 in FIG. 8, shows a lens that provides a 60° beam width centered at about 35° with about a 10% variation in luminous intensity across its width.

Although Examples 1-3 used ray-tracing technology to model the behavior of a lens, and particularly its luminous intensity over a range of angles, that need not be the case in all embodiments. In some embodiments, it may be simpler to determine a basic set of facet angles and lengths, construct an asymmetrical lens with those facet angles and lengths, and measure the luminous intensity of that actual, manufactured lens with an instrument such as a goniophotometer. For example, additive manufacturing techniques may be used to rapidly prototype asymmetrical lenses in some embodiments.

It should also be apparent that while luminous intensity plots are used in certain cases to determine the beam width and any variations in beam intensity, the plots shown in the drawing figures are but one tool that may be used for that purpose. Luminous intensity may be reported in any convenient manner, and other measures of the uniformity of a beam of light may be used in other embodiments.

As used in this description, the term “about” refers to the fact that the quoted number or range can change without changing the described effect or outcome. If it cannot be determined what number or range would cause the described effect or outcome to change, the term “about” should be construed to refer to the quoted number or range plus or minus 5%.

While the invention has been described with respect to certain embodiments, the description is intended to be exemplary, rather than limiting. Modifications and changes may be made within the scope of the invention, which is defined by the appended claims.

1. A cover lens for a linear luminaire, comprising:
a body having a substantially constant cross-section over its length and a refractive portion including
an inner surface with a plurality of facets, each of the plurality of facets having a facet angle and a facet length, the plurality of facets being physically asymmetrical so as to cause or allow an asymmetrical refraction of light emitted toward the inner surface, roots of each of the plurality of facets lying in a plane or in a set of parallel planes, and
an outer surface that is continuously curved or splined, at least a portion of the body thickening from the roots of each of the plurality of facets to the outer surface, such that the body has a non-uniform thickness from the roots of each of the plurality of facets to the outer surface; and
cover-engaging structure;
wherein the facet angle and the facet length of each of the plurality of facets and a curvature or curvatures of the outer surface are coordinated so as to cause the asymmetrical refraction of light to be centered at a desired angle; and
wherein the facet angle and the facet length of each of the plurality of facets and the curvature or curvatures of the outer surface are coordinated to give the asymmetrical refraction of light a predefined beam width that is different than an unrefracted beam width of the light emitted toward the inner surface, with at least some of the plurality of facets arranged to aim some of the light emitted toward the inner surface light away from the desired angle.

2.-3. (canceled)

4. The cover lens of claim 1, wherein at least some of the facet angles are different from other facet angles in the plurality of facets.

5. The cover lens of claim 1, wherein at least some of the facet lengths are different from other facet lengths in the plurality of facets.

6. The cover lens of claim 1, wherein the outer surface is splined to have a plurality of curved segments corresponding to each of the plurality of facets.

7. The cover lens of claim 1, wherein the body further comprises one or more non-refractive portions, the one or more non-refractive portions made of or including an opaque material.

8. A linear luminaire, comprising:
a channel having cover-engaging structure;
a strip of linear lighting installed in the channel; and
a cover lens according to claim 1.

9. A method of designing an asymmetrical lens, comprising:
given a defined angle and a refractive index for an optical material, defining a number of facets;
defining a principal ray for each of the facets;
based on the principal rays, calculating a facet angle for each of the facets;
defining a facet length for each of the facets; and
defining a spline or curve for an outer surface of the asymmetrical lens.

10. The method of claim 9, wherein said calculating comprises solving for the angle to a normal to a surface of each of the facets.

11. The method of claim 10, wherein said solving uses the equation:
$${θ}_{1} = \frac{α - {U}_{0}}{2} + {sin}^{- 1} ( \frac{sin {θ}_{1}}{n} )$$
in which θ₁ is the angle to the normal to the surface, α is the defined angle, U₀ is the angle to a normal of a center of an emitting surface of an LED light engine, and n is the refractive index of the optical material.

12. The method of claim 9, wherein said calculating comprises aiming each of the principal rays at a different defined angle.

13. The method of claim 12, wherein the different defined angles are separated by a constant angular distance from one another.

14. The method of claim 9, further comprising adjusting one or both of the facet angles or the facet lengths based on modeled or measured luminous intensity over a range of angles.

15. The cover lens of claim 1, wherein the asymmetrical refraction of light is substantially uniform in luminous intensity across the predefined beam width.

16. The cover lens of claim 15, wherein the asymmetrical refraction of light has a variation in the luminous intensity of about 10% or less.

17. A cover lens for a linear luminaire, comprising:
a body having a substantially constant cross-section over its length and a refractive portion including
an inner surface with a plurality of facets, the plurality of facets spaced over and covering an entire width of the refractive portion, each of the plurality of facets having a facet angle, a root, and a facet length, the plurality of facets being physically asymmetrical so as to cause or allow an asymmetrical refraction of light emitted toward the inner surface, and
an outer surface that is continuously curved or splined,
the body having a non-uniform thickness between respective roots of each of the plurality of facets and the outer surface; and
cover-engaging structure;
wherein the facet angle and the facet length of each of the plurality of facets and a curvature or curvatures of the outer surface are coordinated so as to cause the asymmetrical refraction of light to be centered at a desired angle.

18. The cover lens of claim 17, wherein the facet angle and the facet length of each of the plurality of facets and the curvature or curvatures of the outer surface are coordinated to give the asymmetrical refraction of light a predefined beam width that is different than an unrefracted beam width of the light emitted toward the inner surface.

19. The cover lens of claim 18, wherein the asymmetrical refraction of light is substantially uniform in luminous intensity across the predefined beam width.

20. The cover lens of claim 17, wherein the body further comprises one or more non-refractive portions, the one or more non-refractive portions made of or including an opaque material.

21. A linear luminaire, comprising:
a channel having cover-engaging structure;
a strip of linear lighting installed in the channel; and
a cover lens according to claim 17.

22. A cover lens for a linear luminaire, comprising:
a body having a substantially constant cross-section over its length and a refractive portion including
an inner surface with a plurality of facets, the plurality of facets spaced over and covering an entire width of the refractive portion, each of the plurality of facets having a facet angle and a facet length, the plurality of facets being physically asymmetrical so as to cause or allow an asymmetrical refraction of light emitted toward the inner surface, and
an outer surface having a plurality of curvatures corresponding to the plurality of facets; and
cover-engaging structure;
wherein the facet angle and the facet length of each of the plurality of facets and the curvature of the outer surface are coordinated so as to cause the asymmetrical refraction of light to be centered at a desired angle.

23. The cover lens of claim 22, wherein the plurality of curvatures form a spline.

24. The cover lens of claim 22, wherein the plurality of curvatures approximate a single, continuous curve that defines the outer surface.
